(19) United States
(12) Patent Application Publication
(10) Pub. No.: US 2026/0094339 A1
(43) Pub. Date: Apr. 2, 2026

(54) METHOD AND SYSTEM OF REMOTE OPERATION FEEDBACK

(71) Applicant: INSTITUTE FOR INFORMATION INDUSTRY, Taipei City (TW)

(72) Inventors: Chi Hsien LIU, Taipei City (TW); Chien Hsin LEE, Taipei City (TW); Shang Ming WANG, Taipei City (TW)

(73) Assignee: INSTITUTE FOR INFORMATION INDUSTRY, Taipei City (TW)

(21) Appl. No.: 18/942,246

(22) Filed: Nov. 8, 2024

(30) Foreign Application Priority Data
Sep. 27, 2024 (TW) 113136889

(51) Int. Cl. G06T 13/80

(52) U.S. Cl. CPC G06T 13/80

(57) ABSTRACT

The present disclosure proposes a method and system of remote operation feedback. The method of remote operation feedback includes: using pieces of training data of a manipulated digital object to perform training to generate a script model, wherein each of the pieces training data includes a training trajectory of the manipulated digital object controlled across degrees of freedom and a corresponding default trajectory type, obtaining pending trajectories of the manipulated digital object controlled across the degrees of freedom from authorized devices by granting the authorized devices to manipulate the manipulated digital object according to an authorization granted command from an authorizing device, inputting the pending trajectories into the script model respectively to obtain concluded trajectory types, outputting at least one animation script to the authorizing device according to the concluded trajectory types and the manipulated digital object when triggered by an authorization revocation command from the authorizing device.

### CROSS-REFERENCE TO RELATED APPLICATIONS

This non-provisional application claims priority under 35 U.S.C. § 119 (a) on Patent Application No(s). 113136889 filed in Republic of China (Taiwan) on Sep. 27, 2024, the entire contents of which are hereby incorporated by reference.

### BACKGROUND

### 1. Technical Field

This disclosure relates to a method and system of remote operation feedback.

### 2. Related Art

Current remote digital teaching mainly takes place in the form of video. In this teaching method, teachers use online platforms to synchronously operate digital or physical teaching materials and provide explanations, while students primarily watch and listen, resulting in one-way teaching interaction. Although this teaching method is convenient and allows students to acquire knowledge in real-time, teachers are unable to interact with students or verify each student's learning status.

To assess students' learning outcomes, it usually requires relying on online or offline evaluation tools. Teachers can only acquire students' learning progress and effectiveness through the statistical analysis results of these assessments and make adjustments to teaching methods or content accordingly. While the above evaluation mechanism can provide a certain level of learning feedback, it is still lacking in immediacy and accuracy. Moreover, if multiple cameras are needed to capture various teaching audio and video streams in the classroom for real-time evaluation, high hardware costs would be required.

### SUMMARY

Accordingly, this disclosure provides a method and system of remote operation feedback.

According to one or more embodiment of this disclosure, a method of remote operation feedback, performed by at least one computing device, includes: using a plurality of pieces of training data of a manipulated digital object to perform training to generate a script model, wherein each of the plurality of pieces of training data comprises a training trajectory of a movement of the manipulated digital object controlled across degrees of freedom and a default trajectory type corresponding to the training trajectory; obtaining a plurality of pending trajectories of a movement of the manipulated digital object controlled across the degrees of freedom from a plurality of authorized devices by granting the plurality of authorized devices to manipulate the manipulated digital object according to an authorization granted command from an authorizing device; inputting the plurality of pending trajectories into the script model to obtain a plurality of concluded trajectory types, respectively; and outputting at least one animation script to the authorizing device according to the plurality of concluded trajectory types and the manipulated digital object when triggered by an authorization revocation command from the authorizing device.

According to one or more embodiment of this disclosure, a system of remote operation feedback includes: a memory device and at least one computing device. The memory device is configured to store a script model. The at least one computing device is connected to the memory device, a plurality of authorized devices and an authorizing device. The at least one computing device is configured to perform: using a plurality of pieces of training data of a manipulated digital object to perform training to generate the script model, wherein each of the plurality of pieces of training data comprises a training trajectory of a movement of the manipulated digital object controlled across degrees of freedom and a default trajectory type corresponding to the training trajectory; obtaining a plurality of pending trajectories of a movement of the manipulated digital object controlled across the degrees of freedom from the plurality of authorized devices by granting the plurality of authorized devices to manipulate the manipulated digital object according to an authorization granted command from the authorizing device; inputting the plurality of pending trajectories into the script model to obtain a plurality of concluded trajectory types, respectively; and outputting at least one animation script to the authorizing device according to the plurality of concluded trajectory types and the manipulated digital object when triggered by an authorization revocation command from the authorizing device.

In view of the above description, the method of remote operation feedback and system according to one or more embodiments may provide synchronized three-dimensional teaching content for teachers and students, addressing the issue of insufficient teaching imagery caused by traditional two-dimensional video images. Further, the method of remote operation feedback and system according to one or more embodiments allows students to independently manipulate the manipulated digital object and feedback the manipulation results to the teacher, addressing the issue of traditional one-way remote teaching method where the teacher performs controlling and explanations while students passively watch. Consequently, the immediacy and interactivity of remote synchronous teaching may be improved without increasing hardware costs.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a system of remote operation feedback according to an embodiment of the present application;

FIG. 2 is a flowchart illustrating a method of remote operation feedback according to an embodiment of the present application;

FIG. 3 is a flowchart illustrating generating pending trajectories of the method of remote operation feedback according to an embodiment of the present application;

FIG. 4 is a flowchart illustrating generating an animation script of the method of remote operation feedback according to an embodiment of the present application; and

FIG. 5 is a schematic diagram illustrating the method of remote operation feedback according to an embodiment of the present application.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

Please refer to FIG. 1, wherein FIG. 1 is a block diagram illustrating a system of remote operation feedback according to an embodiment of the present application. As shown in FIG. 1, the system 1 of remote operation feedback includes a memory device 11 and at least one computing device 12. The memory device 11 is in communication with or electrically connected to the computing device 12. The memory device 11 and the computing device 12 may be integrated into an interacting server.

The memory device 11 is configured to store script model. The script model is a trained model, and the script model may include at least one of a convolutional neural network (CNN) model, a recurrent neural network (RNN) model and a long short-term memory (LSTM). The memory device 11 may include one or more memories, the memory may be a non-volatile memory (NVM), such as a read-only memory (ROM), a flash memory, and/or a non-volatile random access memory (NVRAM) etc.

The computing device 12 may be further in communication with or electrically connected to an authorizing device and a plurality of authorized devices. The authorizing device may be a terminal device at the teacher's end, and the authorized devices may be terminal devices at the students' end. The authorizing device and the authorized devices may each be one of a desktop computer, a smartphone, an augmented reality headset, a virtual reality headset, a mixed reality headset, or a holographic projection device etc. The computing device 12 is configured to perform one or more embodiments of the method of remote operation feedback described below. Further, in an embodiment where the number of the computing device 12 is one, the computing device 12 may be configured to perform all the steps of the method of remote operation feedback described below; and in an embodiment where the number of the computing device 12 is more than one, the computing devices 12 may be configured to perform training to generate the script model and perform the other steps of the method of remote operation feedback, respectively. The computing device 12 may include one or more processors, the processor is, for example, a central processing unit, a graphics processing unit, a microcontroller, a programmable logic controller, or other processors with signal processing capabilities.

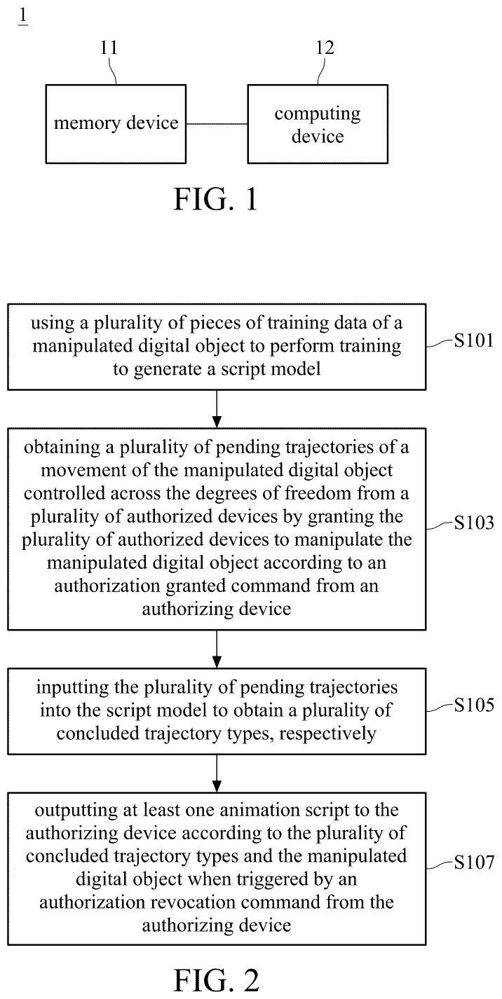

Please refer to FIG. 1 and FIG. 2, wherein FIG. 2 is a flowchart illustrating a method of remote operation feedback according to an embodiment of the present application. As shown in FIG. 2, the method of remote operation feedback includes: step S101: using a plurality of pieces of training data of a manipulated digital object to perform training to generate a script model; step S103: obtaining a plurality of pending trajectories of a movement of the manipulated digital object controlled across the degrees of freedom from a plurality of authorized devices by granting the plurality of authorized devices to manipulate the manipulated digital object according to an authorization granted command from an authorizing device; step S105: inputting the plurality of pending trajectories into the script model to obtain a plurality of concluded trajectory types, respectively; and step S107: outputting at least one animation script to the authorizing device according to the plurality of concluded trajectory types and the manipulated digital object when triggered by an authorization revocation command from the authorizing device.

In step S101, the computing device 12 collects the pieces of training data of the manipulated digital object to perform training to obtain the script model. The manipulated digital object may be any virtual object, and may be a two-dimensional virtual object or a three-dimensional virtual object. For example, when the method of remote operation feedback and system is applied in digital blocks education, the manipulated digital object may be a digital LEGO model or a digital animal model etc.; when the method of remote operation feedback and system is applied in circuit board assembly teaching, the manipulated digital object may be a digital circuit board and/or one or more digital electronic components, the present disclosure does not limit the type of the manipulated digital object.

Each of the pieces of training data includes a training trajectory of a movement of the manipulated digital object controlled across the degrees of freedom by a user and a default trajectory type corresponding to the training trajectory. The degrees of freedom may be six degrees of freedom, including forward/backward (surge), up/down (heave), left/right (sway), pitch, yaw, and roll. One training trajectory may include a plurality of continuous poses, each of the poses is configured to represent an aspect of the manipulated digital object, that is, the posture/position and orientation of the manipulated digital object. For example, the front of the model may be one aspect/pose, the side of the model may be another aspect/pose. Further, movement magnitude between one pose and the next pose may be represented by a spatial vector, wherein the spatial vector may indicate the amount of movement and movement direction from one pose to the next pose. The default trajectory type may indicate the moving pattern of the training trajectory. The default trajectory type may be used as a label of the training trajectory. The computing device 12 may perform supervised training according to the training data and the default trajectory type. For example, the training trajectory is consisted of a plurality of continuous poses, and the training trajectory may be a movement trajectory of the manipulated digital object changing from the first one of the poses to the final one of the poses. The training trajectory is, for example, the movement of the manipulated digital object rotating 15° to the right, and the default trajectory type may be rotating 15° to the right. The computing device 12 may designate a plurality of trajectories, among the training trajectories, with movement differences from the default trajectory type that fall within a default range as corresponding to the same default trajectory type. For example, a lower limit of the default range is −2.5°, an upper limit of the default range is 2.5°, and the computing device 12 may determine that the manipulated digital object rotating 14° to the right, the manipulated digital object rotating 13° to the right and the manipulated digital object rotating 16° to the right all correspond to the default trajectory type of the manipulated digital object rotating 15° to the right. The manipulated digital object rotating 15° to the right is merely an example, the default trajectory type may also include moving upward by 3 centimeters etc.; or, the default trajectory type may also include the movement of installing one object onto another object or removing one object from another object, such as installing a capacitor on a circuit board, removing a LEOG piece from a base etc. The present disclosure does not limit the content of the default trajectory type.

In step S103, the computing device 12 obtains the authorization granted command from the authorizing device, and grants the authorized devices to manipulate the manipulated digital object according to the authorization granted command. The computing device 12 then obtains the pending trajectories from the authorized devices, where the manipulated digital object is controlled by the users of the authorized devices across the degrees of freedom. Further, more than one of the pending trajectories may be received from a corresponding one of the authorized devices. In other words, the computing device 12 may receive one or more pending trajectories from each of the authorized devices. One pending trajectory may include a plurality of movement magnitudes, and the movement magnitudes correspond to the amount of movement and movement direction at the degrees of freedom.

The authorization granted command may include a designated pose, and an initial pose of the manipulated digital object may be the designated pose, wherein one pose may be a static/still pose of the manipulated digital object at a corresponding time point. In other words, when the computing device 12 grants the authorized devices of authorization, the computing device 12 may output the designated pose to the authorized devices for the users of the authorized devices to start manipulating the manipulated digital object starting from the initial pose. In an embodiment, the designated pose may be the final pose of the manipulated digital object when the manipulation of the manipulated digital object at the authorizing device ends; in another embodiment, the designated pose may be any pose during the manipulation of the manipulated digital object at the authorizing device, for example, the initial default pose of the manipulated digital object at the authorizing device.

In step S105, the computing device 12 inputs the pending trajectories into the script model, respectively, to obtain the concluded trajectory types. Continuing from the example of the default trajectory type above, the concluded trajectory types may include rotating 15° to the right, the present disclosure is not limited thereto. Further, depending on the pending trajectories, the pending trajectories may correspond to the same concluded trajectory type.

In step S107, the computing device 12 is triggered by the authorization revocation command coming from the authorizing device to generate and output one or more animation scripts to the authorizing device according to the concluded trajectory types and the manipulated digital object, thereby providing feedback of the result of the authorized devices manipulating the manipulated digital object to the authorizing device. The authorization revocation command may be used to indicate the computing device 12 to stop receiving the pending trajectories from the authorized devices and/or indicate the computing device 12 ends the authorization of the authorized devices manipulating the manipulated digital object. The computing device 12 may generate the animation script for each of the concluded trajectory types, or the computing device 12 may generate one or more animation scripts for one or more of the concluded trajectory types. The animation script may include spatial vectors of the manipulated digital object at a series of time points. Accordingly, the animation script may be rendered into a playable animation by a three-dimensional animation engine.

The method of remote operation feedback and system according to one or more embodiments may provide synchronized three-dimensional teaching content for teachers and students, addressing the issue of insufficient teaching imagery caused by traditional two-dimensional video images. Further, the method of remote operation feedback and system according to one or more embodiments allows students to independently manipulate the manipulated digital object and feedback the manipulation results to the teacher, addressing the issue of traditional one-way remote teaching method where the teacher performs controlling and explanations while students passively watch. Consequently, the immediacy and interactivity of remote synchronous teaching may be improved without increasing hardware costs.

It should be noted that the manipulated digital object may be a static object or a dynamic object. When the manipulated digital object is a static object, the manipulated digital object received by the authorized devices may be static image, such as the manipulated digital object in a still position; and when the manipulated digital object is a dynamic object, the manipulated digital object received by the authorized devices may be an animation consisted of a series of poses of the manipulated digital object.

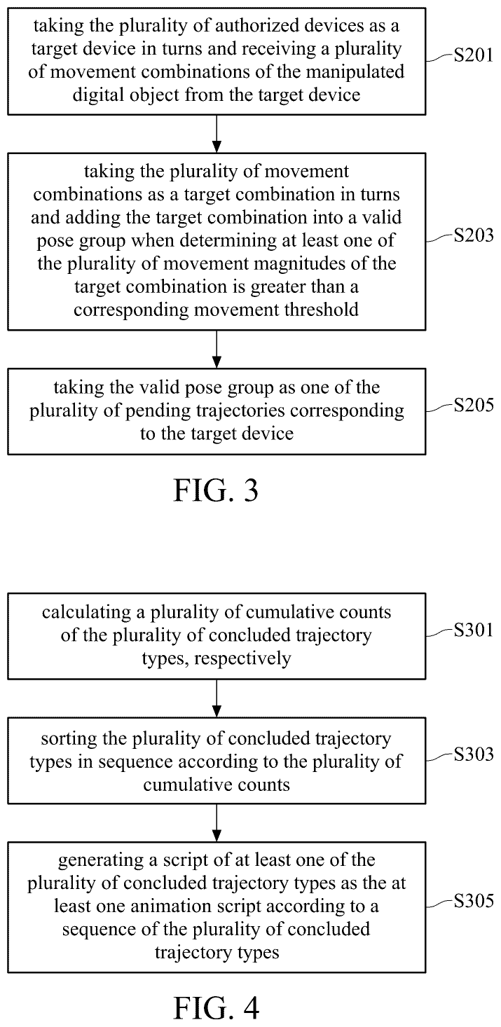

Please refer to FIG. 1 and FIG. 3, wherein FIG. 3 is a flowchart illustrating generating pending trajectories of the method of remote operation feedback according to an embodiment of the present application. FIG. 3 may be regarded as a detailed flowchart of an embodiment of obtaining the pending trajectories of the movement of the manipulated digital object controlled across the degrees of freedom from the authorized devices in step S103 of FIG. 2. As shown in FIG. 3, obtaining the pending trajectories may include: step S201: taking the plurality of authorized devices as a target device in turns and receiving a plurality of movement combinations of the manipulated digital object from the target device; step S203: taking the plurality of movement combinations as a target combination in turns and adding the target combination into a valid pose group when determining at least one of the plurality of movement magnitudes of the target combination is greater than a corresponding movement threshold; and step S205: using the valid pose group as one of the plurality of pending trajectories corresponding to the target device. It should be noted that the present disclosure does not limit the sequence of performing step S201 and step S203, and step S201 and step S203 may be performed at the same time. Although step S203 is illustrated as performed after step S201 in FIG. 3, the present disclosure does not intend to limit that step S203 is performed only after all of the movement combinations are received. For example, the comparison between the movement magnitudes of the movement combination and the movement thresholds may be performed after obtaining one movement combination.

In step S201, the computing device 12 may use each of the authorized devices as the target device in turns, and receive the movement combinations of the manipulated digital object from the target device. Each of the movement combinations may include the movement magnitudes at the degrees of freedom, respectively. Each of the movement magnitudes may be the amount of movement. For example, one movement combination includes six movement magnitudes at six degrees of freedom, respectively, wherein the values of the movement magnitudes may be zero or non-zero.

In step S203, the computing device 12 may use each of the movement combinations as the target combination in turns, and determine whether the movement magnitudes in the target combination are greater than their respective movement thresholds, wherein the computing device 12 may determine whether the absolute values of the movement magnitudes are greater than their respective movement thresholds. Each movement threshold indicates that the movement magnitude in the corresponding degree of freedom is sufficiently large to be considered as a valid motion. The computing device 12 may add the target combination to the valid pose group if at least one of the movement magnitudes of the target combination is greater than the corresponding movement threshold. In other words, among the six movement magnitudes of the target combination, if any one of the movement magnitudes exceeds its corresponding movement threshold, the computing device 12 may include that target combination in the valid pose group; otherwise, the computing device 12 may discard that target combination. The movement thresholds corresponding to the degrees of freedom may be the same or different from each other, and the movement thresholds may be set by the user according to actual needs.

Take equation 1 to equation 4 below for example, the computing device 12 sets the initial pose Initialₚₒₛₑ as P₀, the computing device 12 adds the target combination D₀ to the initial pose P₀ to update the valid pose group P₁ when determining that at least one of the movement magnitudes of the target combination D₀ is greater than the corresponding movement threshold; the computing device 12 adds the target combination D₁ to the valid pose group P₁ to update the valid pose group into P₂ when determining that at least one of the movement magnitudes of the next target combination D₁ is greater than the corresponding movement threshold. The computing device 12 may repeat the above operation to finally obtain the valid pose group Pₜ including valid target combinations connected in sequence, wherein t represents the number of the valid pose group after the update, and t may represent the number of movement combinations added into the valid pose group, wherein the initial value of t may be 1.

$${Initial}_{p o s e} = {P}_{0} \qquad [ equation 1 ]$$

$${P}_{1} = {P}_{0} + {D}_{0} \qquad [ equation 2 ]$$

$${P}_{2} = {P}_{1} + {D}_{1} \qquad [ equation 3 ]$$

$${P}_{t} = {P}_{t - 1} + {D}_{t - 1} \qquad [ equation 4 ]$$

In step S205, after the computing device 12 finishes performing step S203 on all of the movement combinations, the computing device 12 may use the valid pose group as one of the pending trajectories corresponding to the target device. Further, a receiving time difference between any two adjacent movement combinations in the valid pose group is not greater than a default value. Specifically, after the computing device 12 receives the next movement combination within a time threshold (default value), the computing device 12 may perform step S203 on said next movement combination; on the contrary, if the computing device 12 does not receive any movement combination within the time threshold (default value), the first movement combination to the current movement combination may be used as a valid pending trajectory. The default value may be set by the user according to actual needs, the present disclosure is not limited thereto.

By collecting the valid pose groups from the authorized devices, the animation script generated subsequently may be made sure to reflect the manipulation habits of the users of the authorized devices accurately, thereby improving the accuracy of content feedback.

Please refer to FIG. 1 and FIG. 4, wherein FIG. 4 is a flowchart illustrating generating an animation script of the method of remote operation feedback according to an embodiment of the present application. FIG. 4 may be regarded as a detailed flowchart of an embodiment of outputting the at least one animation script to the authorizing device according to the concluded trajectory types and the manipulated digital object in step S107 of FIG. 2. As shown in FIG. 4, generating the animation script may include: step S301: calculating a plurality of cumulative counts of the plurality of concluded trajectory types, respectively; step S303: sorting the plurality of concluded trajectory types in sequence according to the plurality of cumulative counts; and step S305: generating a script of at least one of the plurality of concluded trajectory types as the at least one animation script according to a sequence of the plurality of concluded trajectory types.

In step S301, the computing device 12 calculates the cumulative count of each of the concluded trajectory types. For example, the computing device 12 calculates the cumulative count of the trajectory of rotating 15° to the right, the cumulative count of the trajectory of moving upward by 3 centimeters, the cumulative count of the trajectory of installing a capacitor onto a circuit board and the cumulative count of the trajectory of removing a LEGO piece from a base etc.

In step S303, the computing device 12 arranges the concluded trajectory types in sequence according to the cumulative counts of the concluded trajectory types. The computing device 12 may sort the concluded trajectory types in descending order based on the cumulative counts.

In step S305, the computing device 12 generates the animation script of at least one of the concluded trajectory types according to the sequence of the sorted concluded trajectory types. Further, the computing device 12 may generate the animation script for only the top-ranked concluded trajectory type, and the computing device 12 may also generate the animation scripts for the concluded trajectory types with rankings not exceeding a predetermined ranking, the present disclosure is not limited thereto. Accordingly, the teacher using the authorizing device may determine which trajectory types are the most popular based on the sorting results and the corresponding animation scripts, and adjust the teaching content accordingly. For example, the authorized device may instantly present animation(s) corresponding to the animation script(s) and select the relevant chapter. The predetermined ranking may be set by the user according to usage needs, and the present disclosure is not limited thereto.

In an embodiment, when the number of the authorized devices does not exceed a default number, the computing device 12 may sort the concluded trajectory types in a first in first out (FIFO) manner. For example, the computing device 12 may sort the concluded trajectory types in sequence according to the sequence of obtaining the pending trajectories. The default number may be set according to usage need, and may be, for example, 2, the present disclosure is not limited thereto. Further, the computing device 12 may perform a statistical analysis using a normal distribution on the concluded trajectory types, converge multiple concluded trajectory types into a single concluded trajectory type, and generate an animation script accordingly. Said single concluded trajectory type may be the one with the highest cumulative count among the inferred trajectory types.

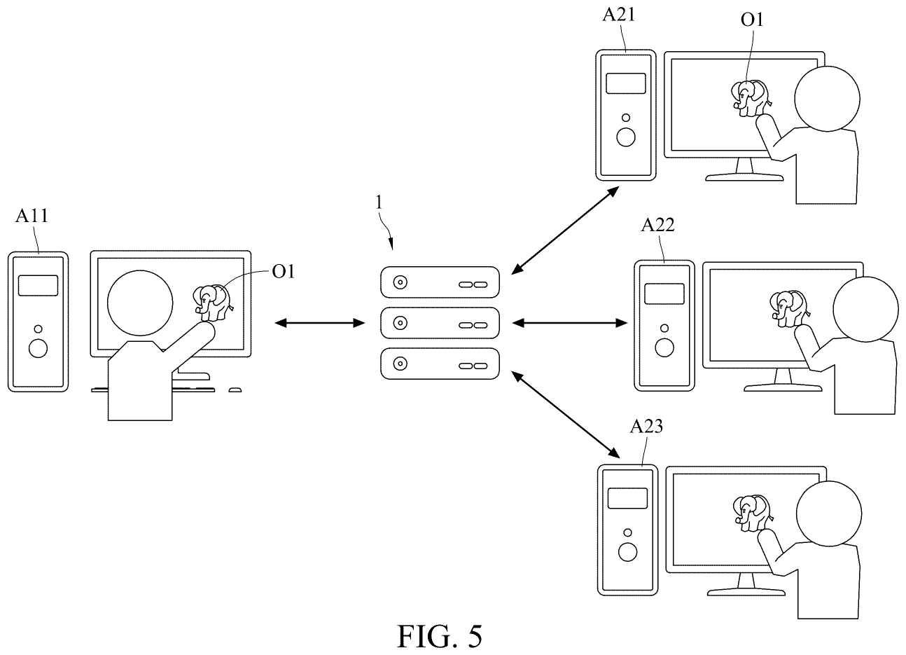

Please refer to FIG. 5, wherein FIG. 5 is a schematic diagram illustrating the method of remote operation feedback according to an embodiment of the present application. FIG. 5 uses a three-dimensional elephant model as an example of the manipulated digital object, but the present disclosure is not limited thereto. In addition, FIG. 5 exemplarily shows an embodiment of three authorized devices A21, A22 and A23, but the present disclosure does not limit the number of the authorized device. Further, FIG. 5 uses computers as the example of the authorizing device A11 and the authorized devices A21, A22 and A23, but the present disclosure is not limited thereto. As shown in FIG. 5, the system 1 of remote operation feedback authorizes the authorized devices A21, A22 and A23 to manipulate the manipulated digital object O1 according to the authorization granted command from the authorizing device A11 and generates the corresponding concluded trajectory types. The system 1 of remote operation feedback is triggered by the authorization revocation command from the authorizing device A11 to output the animation script to the authorizing device A11 according to the concluded trajectory types and the manipulated digital object O1.

The following uses FIG. 5 with 15° as an interval for example for explanation. In an exemplary use case, the initial pose of the manipulated digital object O1 is the front view of a standing elephant, wherein the pose described herein may be a first image of the manipulated digital object presented on the user interfaces of the authorized devices A21, A22 and A23. The authorized device A21 turns the manipulated digital object O1 to the right by 13°, turns the manipulated digital object O1 upward by 170° then turns the manipulated digital object O1 to the left by 10°. The concluded trajectory types generated by the system 1 of remote operation feedback are turning to the right by 15°, turning upward by 180° and turning to the left by 15°. At this point, the pose (aspect) of the manipulated digital object O1 is the tail of an upside-down elephant. The authorized device A22 turns the manipulated digital object O1 to the left by 170° then turns the manipulated digital object O1 downward by 5°. The concluded trajectory types generated by the system 1 of remote operation feedback are turning to the left by 180° and turning downward by 15°. At this point, the pose (aspect) of the manipulated digital object O1 is the nose of a standing elephant. The authorized device A23 turns the manipulated digital object O1 to the right by 15°, turns the manipulated digital object O1 upward by 180° then turns the manipulated digital object O1 to the left by 5°. The concluded trajectory types generated by the system 1 of remote operation feedback are turning to the right by 15°, turning upward by 180° and turning to the left by 15°. At this point, the pose (aspect) of the manipulated digital object O1 is the tail of an upside-down elephant.

The cumulative counts obtained by the system 1 of remote operation feedback calculating the number of each aspect are: the cumulative count of the tail of an upside-down elephant is 2, the cumulative count of the nose of a standing elephant is 1. Further, the convergence result obtained by the system 1 of remote operation feedback performing the statistical analysis using the normal distribution on the concluded trajectory types may be: turning to the right by 15°, turning upward by 180° and then turning to the left by 15°. Therefore, the first image of the animation script may be the front view of a standing elephant, and the final image of the animation script may be the tail of an upside-down elephant. The path from the front view of a standing elephant to the tail of an upside-down elephant may be the convergence result. That is, the path may be turning to the right by 15°, turning upward by 180° and then turning to the left by 15°.

In addition, the method of remote operation feedback and system according to one or more embodiments described above may be adapted to mixed reality, virtual reality and pure virtual environment etc., the present disclosure is not limited thereto.

The method of remote operation feedback and system according to one or more embodiments may provide synchronized three-dimensional teaching content for teachers and students, addressing the issue of insufficient teaching imagery caused by traditional two-dimensional video images. Further, the method of remote operation feedback and system according to one or more embodiments allows students to independently manipulate the manipulated digital object and feedback the manipulation results to the teacher, addressing the issue of traditional one-way remote teaching method where the teacher performs controlling and explanations while students passively watch. Consequently, the immediacy and interactivity of remote synchronous teaching may be improved without increasing hardware costs. By collecting the valid pose groups from the authorized devices, the animation script generated subsequently may be made sure to reflect the manipulation habits of the users of the authorized devices accurately, thereby improving the accuracy of content feedback. By sorting the concluded trajectory types according to the cumulative counts of the concluded trajectory types, the teacher using the authorizing device may determine which trajectory types are the most popular based on the sorting results and the corresponding animation scripts, and adjust the teaching content accordingly. For example, the authorized device may instantly present animation(s) corresponding to the animation script(s) and select the relevant chapters.

What is claimed is:

1. A method of remote operation feedback, performed by at least one computing device, comprising:
using a plurality of pieces of training data of a manipulated digital object to perform training to generate a script model, wherein each of the plurality of pieces of training data comprises a training trajectory of a movement of the manipulated digital object controlled across degrees of freedom and a default trajectory type corresponding to the training trajectory;
obtaining a plurality of pending trajectories of a movement of the manipulated digital object controlled across the degrees of freedom from a plurality of authorized devices by granting the plurality of authorized devices to manipulate the manipulated digital object according to an authorization granted command from an authorizing device;
inputting the plurality of pending trajectories into the script model to obtain a plurality of concluded trajectory types, respectively; and
outputting at least one animation script to the authorizing device according to the plurality of concluded trajectory types and the manipulated digital object when triggered by an authorization revocation command from the authorizing device.

2. The method of remote operation feedback according to claim 1, wherein obtaining the plurality of pending trajectories of the movement of the manipulated digital object controlled across the degrees of freedom from the plurality of authorized devices comprises:
taking the plurality of authorized devices as a target device in turns and receiving a plurality of movement combinations of the manipulated digital object from the target device, wherein each of the plurality of movement combinations comprises a plurality of movement magnitudes across the degrees of freedom;
taking the plurality of movement combinations as a target combination in turns and adding the target combination into a valid pose group when determining at least one of the plurality of movement magnitudes of the target combination is greater than a corresponding movement threshold; and
taking the valid pose group as one of the plurality of pending trajectories corresponding to the target device.

3. The method of remote operation feedback according to claim 2, wherein a receiving time difference between any two adjacent movement combinations among the plurality of movement combinations in the valid pose group is not greater than a default value.

4. The method of remote operation feedback according to claim 1, wherein outputting the at least one animation script to the authorizing device according to the plurality of concluded trajectory types and the manipulated digital object comprises:
calculating a plurality of cumulative counts of the plurality of concluded trajectory types, respectively;
sorting the plurality of concluded trajectory types in sequence according to the plurality of cumulative counts; and
generating a script of at least one of the plurality of concluded trajectory types as the at least one animation script according to a sequence of the plurality of concluded trajectory types.

5. The method of remote operation feedback according to claim 1, wherein the authorization granted command comprises a designated pose, and an initial pose of the manipulated digital object is the designated pose.

6. The method of remote operation feedback according to claim 1, wherein more than one of the plurality of pending trajectories are received from a corresponding one of the plurality of authorized devices.

7. A system of remote operation feedback, comprising:
a memory device configured to store a script model; and
at least one computing device connected to the memory device, a plurality of authorized devices and an authorizing device, the at least one computing device configured to perform:
using a plurality of pieces of training data of a manipulated digital object to perform training to generate the script model, wherein each of the plurality of pieces of training data comprises a training trajectory of a movement of the manipulated digital object controlled across degrees of freedom and a default trajectory type corresponding to the training trajectory;
obtaining a plurality of pending trajectories of a movement of the manipulated digital object controlled across the degrees of freedom from the plurality of authorized devices by granting the plurality of authorized devices to manipulate the manipulated digital object according to an authorization granted command from the authorizing device;
inputting the plurality of pending trajectories into the script model to obtain a plurality of concluded trajectory types, respectively; and
outputting at least one animation script to the authorizing device according to the plurality of concluded trajectory types and the manipulated digital object when triggered by an authorization revocation command from the authorizing device.

8. The system of remote operation feedback according to claim 7, wherein the at least one computing device performing obtaining the plurality of pending trajectories of the movement of the manipulated digital object controlled across the degrees of freedom from the plurality of authorized devices comprises:
taking the plurality of authorized devices as a target device in turns and receiving a plurality of movement combinations of the manipulated digital object from the target device, wherein each of the plurality of movement combinations comprises a plurality of movement magnitudes across the degrees of freedom;
taking the plurality of movement combinations as a target combination in turns and adding the target combination into a valid pose group when determining at least one of the plurality of movement magnitudes of the target combination is greater than a corresponding movement threshold; and
taking the valid pose group as one of the plurality of pending trajectories corresponding to the target device.

9. The system of remote operation feedback according to claim 8, wherein a receiving time difference between any two adjacent movement combinations among the plurality of movement combinations in the valid pose group is not greater than a default value.

10. The system of remote operation feedback according to claim 7, wherein the at least one computing device performing outputting the at least one animation script to the authorizing device according to the plurality of concluded trajectory types and the manipulated digital object comprises:
calculating a plurality of cumulative counts of the plurality of concluded trajectory types, respectively;
sorting the plurality of concluded trajectory types in sequence according to the plurality of cumulative counts; and
generating a script of at least one of the plurality of concluded trajectory types as the at least one animation script according to a sequence of the plurality of concluded trajectory types.

11. The system of remote operation feedback according to claim 7, wherein the authorization granted command comprises a designated pose, and an initial pose of the manipulated digital object is the designated pose.

12. The system of remote operation feedback according to claim 7, wherein more than one of the plurality of pending trajectories are received from a corresponding one of the plurality of authorized devices.
